(19) United States
(12) Patent Application Publication
(10) Pub. No.: US 2007/0223626 A1
(43) Pub. Date: Sep. 27, 2007

(54) Dynamic analog power management in mobile station receivers

(76) Inventor: Shay Waxman, Haifa (IL)

Correspondence Address: INTEL CORPORATION;c/o INTELLEVATE, LLC, P.O. BOX 52050, MINNEAPOLIS, MN, 55402, US

(21) Appl. No.: 11/386,146

(22) Filed: Mar. 21, 2006

(51) Int. Cl. H04L 27/00

(52) U.S. Cl. 375/316

(57) ABSTRACT

Methods and systems for communicating in a wireless network include adjusting power consumption of an analog portion of a receiver in a mobile device based on the needs of the mobile device. In one example, either the gain or noise figure of the low noise amplifier (LNA) in the receiver may be adjusted based on the strength of a received signal. In other examples, the resolution of the receiver analog-to-digital converter (ADC) may be varied based on the signal strength. The dynamic adaptation of analog receiver components for high-end performance when needed and low-end performance when possible further enables a reduction of power consumption in a mobile wireless device.

### BACKGROUND OF THE INVENTION

One of the main concerns in the design of mobile wireless communications devices is their consumption of power which relates directly to battery life for a mobile device. The power consumption of a particular mobile wireless device may vary during the different modes of operation or usage of the device.

Most conventional power reduction techniques in wireless mobile devices have focused on power reduction for the transmit or transmitter (TX) portion of a device because the TX may be a dominant consumer of power in usage models such as voice of Internet Protocol (VOIP). Receiving or receiver (RX) power reduction can also be effective in extending the battery life of a mobile device, particularly during periods of low use of a device. For example, in some wireless local area network (WLAN) devices, an idle associated mode of operation has been adopted which allows a receiver to be turned off or inactive except during particular beacon time intervals, which may be determined by an associated access point (AP).

Dynamic RX power management techniques have not previously been seriously pursued because, at least in part, a minimum RX sensitivity or error vector magnitude (EVM) of a device is often dictated by an associated standard for supporting high-range/high-throughput devices. These standards usually take a theoretical minimum sensitivity requirement and add to that, a noise figure and implementation loss to derive a requirement that can be reached using only high-end analog and digital signal processing (DSP) implementations. In some network standards however, for example, standards relating wireless local area networks (WLANs) or even certain broadband wireless metropolitan area networks (WMANs), this is not necessarily the case.

For example, in certain of these network implementations, there is a gap between the theoretical high-end sensitivity desired for high-range high-rate device operation and the minimum sensitivity dictated by the associated standard. By way of example only, some WLAN high-end devices may have a sensitivity capability of −96 dBm whereas the Institute for Electrical and Electronics Engineers (IEEE) 802.11a/g WLAN standards (1999, 2003) may require a sensitivity of only −82 dBM at a rate of 6 Mbps. Thus the power consumption of certain of these high-end/high-performance RX mobile device designs, in some cases, may be wasteful. On the other hand, the high-performance RX designs in mobile devices can offer obvious increased range/rate advantages. Thus it would be desirable for an RX design in a mobile device to be able to dynamically adjust its sensitivity to provide both low RX power consumption when possible and extended range/high-rate operation.

### BRIEF DESCRIPTION OF THE DRAWING

Aspects, features and advantages of the present invention will become apparent from the following description of the invention in reference to the appended drawing in which like numerals denote like elements and in which:

FIG. 1 is block diagram of a wireless mobile device receiver configuration according to one embodiment of the present invention;

FIG. 2 is a flow diagram showing a general method for dynamically managing power consumption of a wireless mobile device according to one embodiment; and

FIG. 3 is a functional block diagram of an exemplary embodiment for a wireless mobile device adapted to perform one or more of the methods of the present invention.

### DETAILED DESCRIPTION OF THE INVENTION

While the following detailed description may describe example embodiments of the present invention in relation to wireless networks utilizing OFDM or Orthogonal Frequency Division Multiple Access (OFDMA) modulation, the embodiments of present invention are not limited thereto and, for example, can be implemented using other multi-carrier or single carrier spread spectrum techniques such as direct sequence spread spectrum (DSSS), frequency hopping spread spectrum (FHSS), code division multiple access (CDMA) and others. While example embodiments are described herein in relation to WLANs, the invention is not limited thereto and can be applied to other types of wireless networks where similar advantages may be obtained. Such networks specifically include, but are not limited to, wireless metropolitan area networks (WMANs), wireless personal area networks (WPANs) and/or wireless wide area networks (WWANs) such as cellular networks and the like.

The following inventive embodiments may be used in a variety of applications including receivers of a mobile wireless radio system. Radio systems specifically included within the scope of the present invention include, but are not limited to, network interface cards (NICs), network adaptors, mobile stations, gateways, bridges, hubs and satellite radiotelephones. Further, the radio systems within the scope of the invention may include satellite systems, personal communication systems (PCS), two-way radio systems, global positioning systems (GPS), two-way pagers, personal computers (PCs) and related peripherals, personal digital assistants (PDAs), personal computing accessories and all existing and future arising systems which may be related in nature and to which the principles of the inventive embodiments could be suitably applied.

Embodiments of the present invention may generally combine desired high-end performance with low-end threshold standard performance by implementing a receiver to have an adaptive analog power management mechanism.

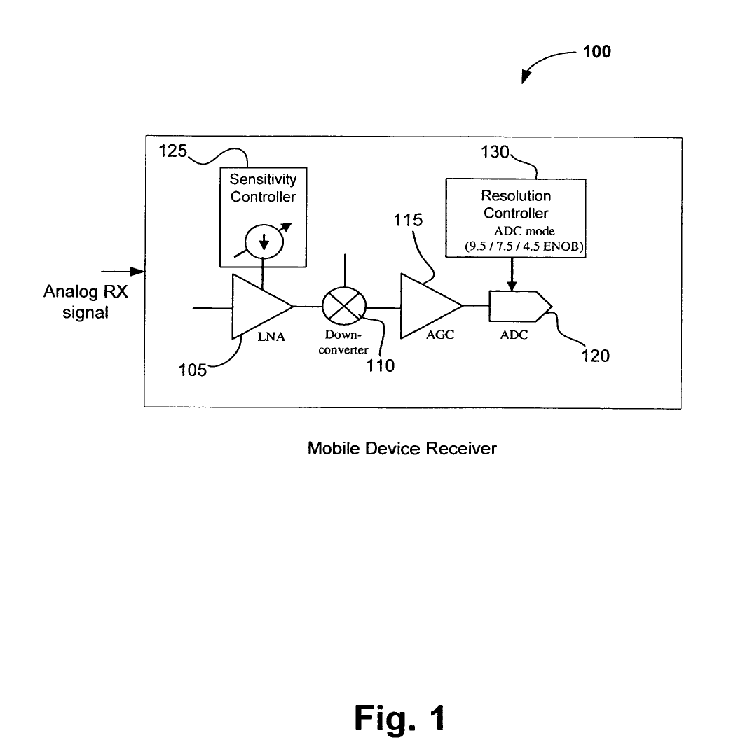

Turning to FIG. 1, a receiver 100 for a wireless mobile device according to one embodiment of the invention may generally include a low noise amplifier 105, a down-converter 110, an automatic gain control circuit 115 and an analog-to-digital converter (ADC) 120. In general operation, these components take an RX analog signal (e.g., a radio frequency (RF) carrier signal down-converted into an intermediate frequency (IF) signal), amplify it, down-convert the amplified signal to an analog baseband signal and then convert the baseband signal into a digital signal by ADC 120 for baseband processing. It should be recognized that receiver 100 may include additional components such as oscillators, attenuators, frequency synthesizers, mixers, etc. which are not depicted in FIG. 1 for sake of simplicity.

LNA 105 and ADC 120 are two of the three (synthesizer, LNA, ADC) major power consumers in a typical receiver chain. In embodiments of the present invention, the noise figure of LNA 105 (i.e., the sensitivity of receiver 100) may be dynamically changed by a variable current controller 125. Alternatively, and or in addition, the power consumed by ADC 120 may be dynamically varied by a controller 130 which may be adapted to control the resolution (i.e., effective number of bits (ENOB)) utilized by ADC 120 for analog-to-digital conversion. In this manner, either or both the sensitivity and the resolution of receiver 100 can be dynamically varied to suit the present needs of receiver 100 by controlling the LNA 105 and ADC 120 respectively. LNA controller 125 and/or ADC resolution controller may be integrated as part of an analog receive power management controller which may be located, partly or entirely, in receiver 100 or external to receiver 100.

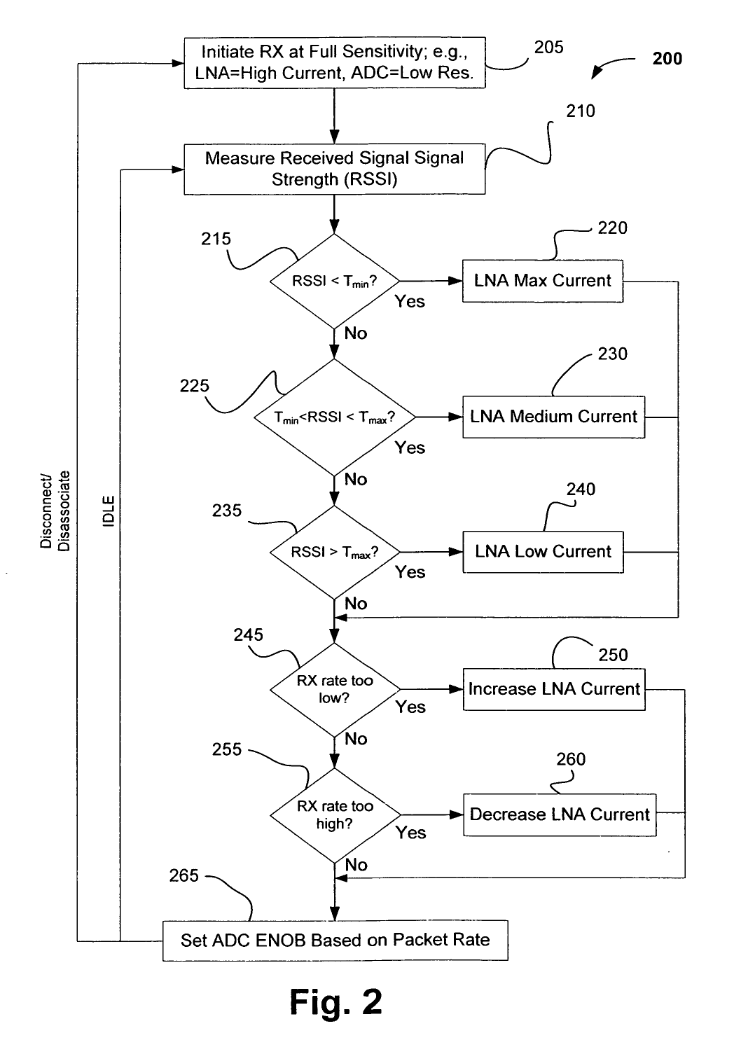

Turning to FIG. 2 an example embodiment for a method 200 to dynamically manage the receiver power consumption of a mobile wireless device may generally include determining 210 a signal strength of connection with another device, adjusting 215-235 the current provided to a LNA in the receiver based, at least in part, on the determined signal strength and adjusting 265 a resolution of the receiver ADC based on the determined signal strength or a rate identified in a packet header.

In a more detailed embodiment, the receiver may initially be set 205 at its highest receive sensitivity (i.e., full current to the LNA) for initial association with another device and the initial ADC resolution may be low, for example an ENOB may be set to ˜4, which is adequate for binary or quaternary phase shift keying (BPSK or QPSK) reception. However, the inventive embodiments are not limited in this respect.

Based on the initial association with the other device, the receive signal strength indication (RSSI) or other signal quality/quantity indication (e.g., signal-to-noise ratio (SNR)) may be measured 210 at the mobile device. In the example of an infrastructure-based WLAN, the association of the mobile device will be with an access point (AP) and the AP beacon may be used for RSSI measurement. In an ad-hoc or wireless mesh network, other initializing beacons or signaling may be measured and the inventive embodiments are not limited to any specific network implementation or signal measurement.

Based on the detected RSSI the receiver may now vary, if necessary, the current to the LNA to accommodate the sensitivity of the receiver to the existing conditions of the connection. For example, if 215 the received signal is weak, that is, the RSSI is less than a threshold minimum (Tₘᵢₙ) (in an example WLAN <˜88 dBm), for example as specified by an associated standard or as necessary to properly receive the beacon or any associated 802.11 packets), the current to the LNA may be set 220 at maximum to maximize receiver sensitivity. In the WLAN example, the standard may call for a minimum sensitivity of −82 dBm at a rate of 6 Mpbs although in the case of only receiving AP beacon transmissions the sensitivity of the receiver could be lower than −82 dBm so long as the beacon is properly received.

In one example embodiment having three mode levels of LNA control, and to which the inventive embodiments are not limited, when 225 the RSSI is between the threshold minimum (Tₘᵢₙ) and a threshold maximum (Tₘₐₓ) (e.g., somewhere between −88 dDm and −82 dDM), the current controlling the noise figure of the LNA may be set 230 to a medium control level to obtain mid-range receiver sensitivity. Similarly, when 235 the RSSI is greater than the Tₘₐₓ (e.g., >˜−82 dBM) the LNA current may be set 240 to a low level thereby reducing the sensitivity, and thus the power consumption, of the receiver. As understood by the skilled artisan, the dynamic adaptation of receiver sensitivity could be performed using several levels of control or just two levels of control and the specific design for receive sensitivity control adjustment can be chosen as suitably desired.

In certain embodiments of the present invention, if either network minimal required rate (for example, known through a traffic specification (TSPEC) or otherwise) or an application requires a rate higher or lower than what is currently supported, the receiver may further increase or lower the LNA current. Therefore, method 200 may further include, if desired, the option to further adjust the receiver sensitivity in accordance with the desired receive rate. For example, if 245 the receive rate is not high enough for the application layer or data link layer requirements, the current to the LNA may be increased 250. Similarly, if 255 the receive rate is higher than needed, the LNA current can be decreased 260 as desired.

As mentioned previously, the default mode for the ADC may be initially set 205 at a basic resolution (e.g., ˜4 ENOB). Thereafter, the ADC resolution may be varied 265 during packet reception according to the packet header rate or the RSSI. For example, in an example embodiment having three modes of ADC operation, the ENOB may be set as follows: ENOB=4.5 bits for BPSK/QPSK modulation; ENOB=7.5 bits for 16 or 64 quadrature amplitude modulation (QAM), and ENOB=9.5 bits for multiple-input multiple-output (MIMO) QAM, although the inventive embodiments are in no way limited to these specific examples. The resolution of the ADC may be varied using ADC devices which are adapted for scaling by varying input current (similar to the LNA of FIG. 1) or in a multi-stage ADC by skipping stages in the ADC although the manner in which the variable resolution ADC is implemented is not important to the inventive embodiments.

If there is any significant idle time between communications received by the wireless mobile device from the associated device (e.g., between AP beacons), method 200 may periodically or when instructed, repeat the process of measuring RSSI and adjusting the sensitivity and resolution of the receiver. If the wireless mobile device disassociates with, or disconnects from, the associated AP (or other device depending on the network), the receiver may reset 205 to its initial sensitivity and/or resolution values.

The degree of changes by which the LNA and ADC change from high-end to low-end state of operation may be suitably determined by a designer to accommodate the requirements of a particular type of network. However, the following scenarios demonstrate potential examples.

Video Streaming at −73 dBm Signal:

After reducing the current to the LNA (FIG. 2; 235, 240) to settle at a receive sensitivity of −82 dBm, the application requires a higher rate of operation (e.g., the rate reached is only 12 Mbps instead of 54 Mbps). In this scenario, the RX analog power management entity will increase (FIG. 2, 250) the LNA current such that the application required 54 Mbps rate is met.

Voice Streaming at −82 dBm Signal:

In this example, the 6 Mbps rate required for voice is met using the low-end mode of operation. As such there is no need to raise currents and the RX power consumption for this application is minimized (6 Mbps and 4.5 bit ADC).

The potential power saving using the RX analog power management schemes of the inventive embodiments is considerable. For example, using only 4-bit ADC for low end reception consumes only 20% of the power used for high-end 10-bit ADC conversion used for MIMO applications (11 mA vs. 50 mA) and thus by dynamically varying the sensitivity of the receiver and selecting the lowest resolution for the ADC necessary for reasonable signal reception, the power consumed by the receiver may be reduced and contribute to extending the battery life of a mobile wireless device.

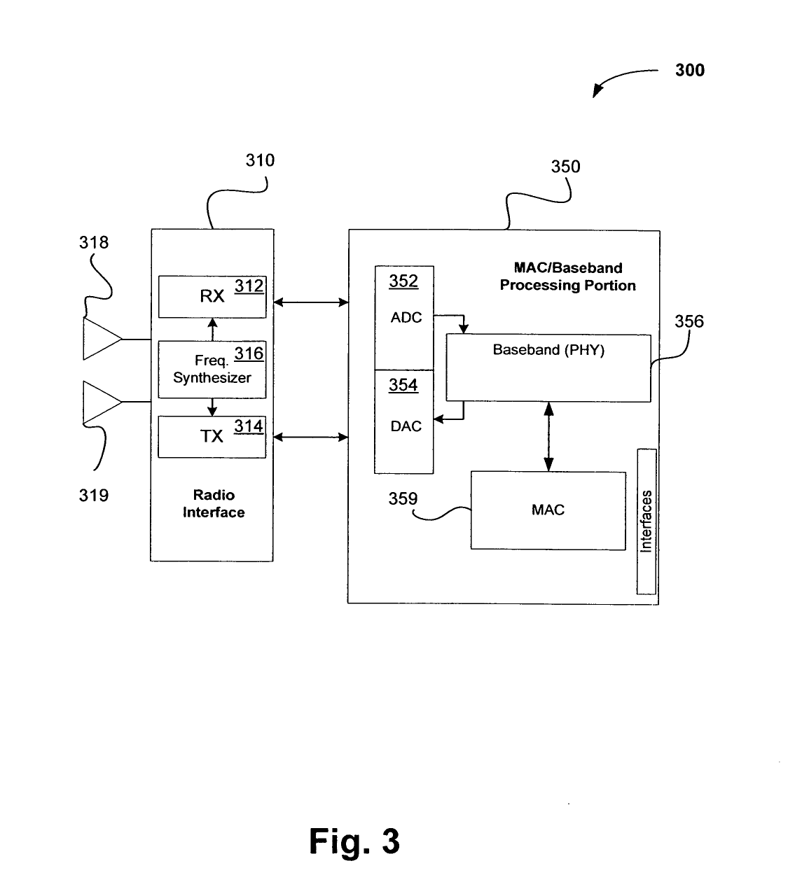

Turning to FIG. 3, an apparatus 300 for use in a wireless network may include a processing circuit 350 including logic (e.g., circuitry, processor(s) and software, or combination thereof) to dynamically control analog power consumption of a receiver as described in one or more of the processes above. In certain embodiments, apparatus 300 may generally include a radio frequency (RF) interface 310 and a baseband and MAC processor portion 350.

In one example embodiment, RF interface 310 may be any component or combination of components adapted to send and receive modulated signals (e.g., OFDM) although the inventive embodiments are not limited to any particular modulation scheme. RF interface 310 may include, for example, a receiver 312 which may include an LNA, down-converter AGC and/or ADC as described previously in reference to FIG. 1. RF interface may also include a transmitter 314 and a frequency synthesizer 316. Interface 310 may also include bias controls, a crystal oscillator and/or one or more antennas 318, 319 if desired. Furthermore, RF interface 310 may alternatively or additionally use external voltage-controlled oscillators (VCOs), surface acoustic wave filters, intermediate frequency (IF) filters and/or radio frequency (RF) filters as desired.

In some embodiments RF interface 310 may be configured to provide OTA link access which is compatible with one or more of the IEEE standards for WPANs, WLANs, WMANs or WWANs, although the embodiments are not limited in this respect.

Processing portion 350 may communicate/cooperate with RF interface 310 to process receive/transmit signals and may include, if not included in RF interface 310, an analog-to-digital converter 352 similar to ADC 120 of FIG. 1. Processing portion may also include a digital-to-analog converter 354 for up converting signals for transmission, and a baseband processor 356 for physical (PHY) link layer processing of respective receive/transmit signals. Processing portion 350 may also include or be comprised of a processing circuit 359 for MAC/data link layer processing.

In certain embodiments of the present invention, MAC circuit 359 may control the variation current to the LNA of receiver 312 and/or the resolution of ADC 352 in a fashion similar to the methods discussed previously. Alternatively or in addition, PHY circuit 356 may share control for certain of these functions or perform these processes independent of MAC processor 359. MAC and PHY processing may also be integrated into a single circuit if desired.

Apparatus 300 may be, for example, a mobile station or a wireless network adaptor for mobile electronic devices. Accordingly, the previously described functions and/or specific configurations of apparatus 300 could be included or omitted as suitably desired.

Embodiments of apparatus 300 may be implemented using single input single output (SISO) architectures. However, as shown in FIG. 3, certain implementations may use MIMO architectures having multiple antennas (e.g., 318, 319) for transmission and/or reception. Further, embodiments of the invention may utilize multi-carrier code division multiplexing (MC-CDMA) multi-carrier direct sequence code division multiplexing (MC-DS-CDMA) for OTA link access or any other existing or future arising modulation or multiplexing scheme compatible with the features of the inventive embodiments.

The components and features of apparatus 300 may be implemented using any combination of discrete circuitry, application specific integrated circuits (ASICs), logic gates and/or single chip architectures. Further, the features of apparatus 300 may be implemented using microcontrollers, programmable logic arrays and/or microprocessors or any combination of the foregoing where suitably appropriate (collectively or individually referred to as “logic”).

Unless contrary to physical possibility, the inventors envision the methods described herein: (i) may be performed in any sequence and/or in any combination; and (ii) the components of respective embodiments may be combined in any manner.

Although there have been described example embodiments of this novel invention, many variations and modifications are possible without departing from the scope of the invention. Accordingly the inventive embodiments are not limited by the specific disclosure above, but rather should be limited only by the scope of the appended claims and their legal equivalents.

The invention claimed is:

1. A method for communicating in a wireless network, the method comprising:
dynamically adjusting power consumption of an analog portion of a receiver based on a strength or quality of a received signal.

2. The method of claim 1 wherein adjusting power consumption of the analog portion of the receiver comprises varying a noise figure of an amplifier in the analog receiver.

3. The method of claim 2 wherein adjusting power consumption of the analog portion of the receiver further comprises varying a resolution of an analog-to-digital converter (ADC) in the analog portion of the receiver.

4. The method of claim 2 wherein varying the noise figure of the amplifier comprises increasing a current to the amplifier if the strength or quality of the received signal is below a minimum threshold or decreasing the current to the amplifier if the strength or quality of the received signal is above a maximum threshold.

5. The method of claim 1 wherein the strength or quality of the received signal comprises a receive signal strength indicator (RSSI).

6. The method of claim 2 wherein the amplifier comprises a low noise amplifier (LNA) and wherein varying the noise figure of the LNA comprises adjusting a control current to the LNA.

7. The method of claim 1 wherein dynamically adjusting power consumption of the analog receiver comprises varying a sensitivity and an analog-to-digital conversion resolution based on the strength or quality of the received signal.

8. An apparatus for wireless communications, the apparatus comprising:
a receiver comprising a low noise amplifier (LNA) and an analog-to-digital converter (ADC); and
a current controller coupled to the LNA and adapted to control a level of current input to the LNA based on a strength or quality of a received signal.

9. The apparatus of claim 8 further comprising a resolution controller coupled to the ADC and adapted to control an effective number of bits (ENOB) utilized by the ADC.

10. The apparatus of claim 9 wherein the current controller and the resolution controller comprise a power manager to reduce power consumption of the receiver based on a receive signal strength indicator (RSSI).

11. The apparatus of claim 9 wherein the resolution controller controls the ENOB utilized by the ADC based on at least one of the strength or quality of the received signal or a packet header rate.

12. The apparatus of claim 8 wherein the apparatus comprises a wireless mobile device.

13. The apparatus of claim 8 wherein the receiver is adapted to receive signals in at least one of a wireless local area network (WLAN) and a wireless metropolitan area network (WMAN).

14. A system for communicating in a wireless network, the system comprising:
a receiver comprising a low noise amplifier (LNA) and an analog-to-digital converter (ADC);
a controller coupled to the LNA and adapted to adjust a current to the LNA based on a strength or quality of a received signal; and
at least two antennas coupled to the receiver to facilitate multiple-input multiple-output (MIMO) reception.

15. The system of claim 14 wherein the controller is further adapted to adjust a resolution of the ADC.

16. The system of claim 14 wherein system comprises a mobile wireless communication device.

17. The system of claim 15 wherein the controller adjust the resolution of the ADC by selecting the effective number of bits (ENOB) utilized by the ADC, wherein the ENOB are selected based a receive signal strength indicator (RSSI) or a transmission rate requested by an application.

18. The system of claim 14 wherein the controller is further adapted to adjust the current to the LNA based on a rate requested by a data link layer controller or an application.

19. An article of manufacture having stored thereon machine readable instructions that when executed by a processing platform result in:
dynamically adjusting power consumption of an analog portion of a receiver based on a strength or quality of a received signal.

20. The article of claim 19 wherein adjusting power consumption of the analog portion of the receiver comprises varying a current to an amplifier in the analog receiver.

21. The article of claim 19 wherein adjusting power consumption of the analog portion of the receiver further comprises varying a resolution of an analog-to-digital converter (ADC) in the analog portion of the receiver.
